(19) United States
(12) Patent Application Publication
(10) Pub. No.: US 2004/0026178 A1
(43) Pub. Date: Feb. 12, 2004

(54) Elevator rope and elevator device

(76) Inventor: Takenobu Honda, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 10/433,102

(22) PCT Filed: Dec. 12, 2001
(86) PCT No.: PCT/JP01/10896

(51) Int. Cl. B66B 11/04

(52) U.S. Cl. 187/251

(57) ABSTRACT

An inner layer rope has a plurality of inner layer strands, in which a plurality of steel wires are twisted together, with an elevator rope for suspending a car of an elevator apparatus. An inner layer cladding made of a resin covers a periphery of the inner layer rope. An outer layer is formed on a peripheral portion of the inner layer cladding. The outer layer has a plurality of outer layer strands in which a plurality of steel wires are twisted together. An outer layer cladding made of a high-friction resin material covers the periphery of the outer layer.

### TECHNICAL FIELD

The present invention relates to an elevator rope for suspending an elevator car, and to an elevator for which the rope is used.

### BACKGROUND ART

A sheave having a diameter at least 40 times the diameter of a rope is conventionally used in an elevator apparatus in order to prevent early abrasion or breakage of the rope with a short service life. Therefore, in order to reduce the diameter of the sheave, it is also necessary to make the rope diameter smaller. However, if the rope diameter is made smaller, then there is a danger that the car will more easily vibrate due to load variations caused by loading baggage in the car or passengers getting on and off the car, and the rope vibrations at the sheave will be transmitted to the car. Further, the number of ropes increases, resulting in a complicate structure of the elevator apparatus. In addition, if the diameter of a driving sheave is made smaller, the driving frictional force is reduced. As a result, the weight of the car must be increased.

### DISCLOSURE OF THE INVENTION

The present invention has been made in order to solve the above-mentioned problems, and an object of the invention is therefore to provide an elevator rope which can be made with smaller diameter while still maintaining high strength, long service life, and high friction, and to provide an elevator apparatus having a compact layout, for which the rope is used.

An elevator rope according to the present invention includes: an inner layer rope having a plurality of inner layer strands in which a plurality of steel wires are twisted together; an inner layer cladding made of a resin and covering a periphery of the inner layer rope; an outer layer formed in a peripheral portion of the inner layer cladding and having a plurality of outer layer strands in which a plurality of steel wires are twisted together; and an outer layer cladding made of a high-friction resin material and covering a periphery of the outer layer.

Also, an elevator apparatus according to the present invention includes: an elevator shaft; a drive machine having a motor, and a driving sheave that is rotated by the motor, which is disposed in an upper portion of the elevator shaft so that a rotating shaft of the driving sheave extends vertically; an elevator rope having an inner layer rope that possesses a plurality of inner layer strands in which a plurality of steel wires are twisted together, an inner layer cladding made of a resin and covering a periphery of the inner layer rope, an outer layer formed in a peripheral portion of the inner layer cladding and possessing a plurality of outer layer strands in which a plurality of steel wires are twisted together, and an outer layer cladding made of a high-friction resin material and covering a periphery of the outer layer, with the elevator rope wound around the driving sheave; a car and a counterweight that are suspended down within the elevator shaft by the elevator rope, and are raised and lowered by the drive machine; a car side guide pulley disposed in an upper portion of the elevator shaft for guiding the elevator rope extending from the driving sheave to the car; and a counterweight side guide pulley disposed in the upper portion of the elevator shaft for guiding the elevator rope extending from the driving sheave to the counterweight, in which the drive machine, the car side guide pulley and the counterweight side guide pulley are disposed so as to overlap with the car within a vertical projection plane, and diameters of the car side guide pulley and the counterweight side guide pulley are set to be equal to or greater than 15 times the diameter of the elevator rope, and equal to or less than 30 times the diameter of the elevator rope.

### BRIEF DESCRIPTION OF THE DRAWINGS

FIG. 1 is a cross sectional diagram of an elevator rope in accordance with Embodiment 1 of the present invention;

FIG. 2 is a side elevation diagram showing the elevator rope of FIG. 1 broken down into layers;

FIG. 3 is a cross sectional diagram of an elevator rope in accordance with Embodiment 2 of the present invention;

FIG. 4 is a cross sectional diagram of an elevator rope in accordance with Embodiment 3 of the present invention;

FIG. 5 is a cross sectional diagram of an elevator rope in accordance with Embodiment 4 of the present invention;

FIG. 6 is a cross sectional diagram of an elevator rope in accordance with Embodiment 5 of the present invention;

FIG. 7 is a cross sectional diagram of main portions of an elevator rope in accordance with Embodiment 6 of the present invention;

FIG. 8 is a cross sectional diagram of an elevator rope in accordance with Embodiment 7 of the present invention;

FIG. 9 is a side elevation diagram showing the elevator rope of FIG. 8 broken down into layers;

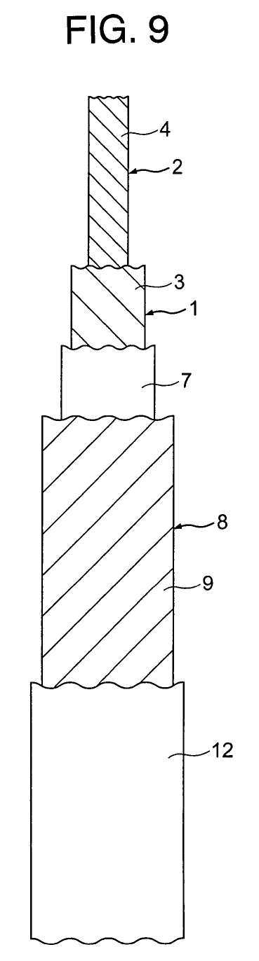

FIG. 10 is a schematic front diagram showing an elevator apparatus in accordance with Embodiment 8 of the present invention; and

FIG. 11 is a plan view showing the elevator apparatus of FIG. 10.

### BEST MODES FOR CARRYING OUT THE INVENTION

Preferred embodiments of the present invention are explained below.

Embodiment 1.

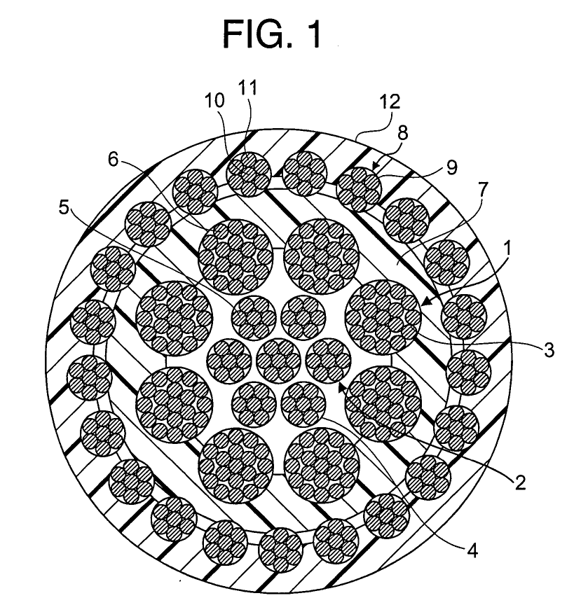

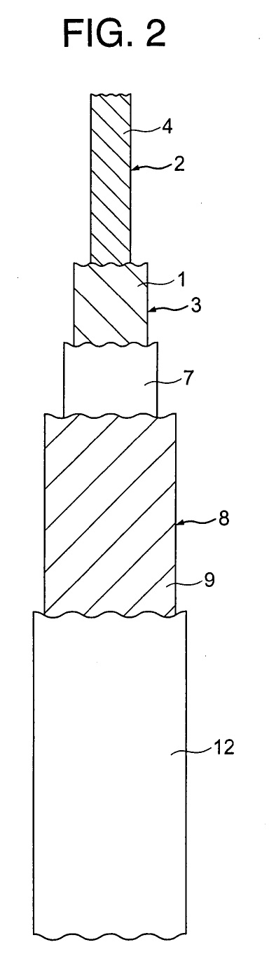

FIG. 1 is a cross sectional diagram of an elevator rope in accordance with Embodiment 1 of the present invention, and FIG. 2 is a side elevation diagram showing the elevator rope of FIG. 1 broken down into layers.

In the figures, an inner layer rope 1 has a core rope 2, and a plurality of inner layer strands 3 provided on the peripheral portion of the core rope 2. The core rope 2 has a plurality of core strands 4. Each of the core strands 4 is structured by a plurality of steel wires 5 that mutually intertwine. The core strands 4 are mutually intertwined, and the inner layer strands 3 are laid in a direction opposite to the core strands 4.

The inner layer strands 3 are structured by mutually intertwining a plurality of steel wires 6. The cross sectional structure of the inner layer strands 3 is a Warrington-type (JIS G3525) structure. Further, gaps exist between adjacent core strands 4, and between the core strands 4 and the inner layer strands 3, but the gaps go away or become smaller with the application of a tensile force to the elevator rope during use.

The diameter of the inner layer rope 1 is set to be equal to or less than 1/27-th of the applicable sheave, that is, the diameter of the sheave around which the elevator rope is wound.

An inner layer cladding 7 made of resin covers the periphery of the inner layer rope 1. The inner layer cladding 7 is made of a polyethylene resin, for example.

An outer layer 8 is formed in a peripheral portion of the inner layer cladding 7. The outer layer 8 has a plurality of outer layer strands 9. Each of the outer layer strands 9 is structured from a center wire 10 disposed in the center, and six peripheral wires 11 disposed on the periphery of the center wire 10. Further, the outer layer strands 9 are laid in a direction opposite to the inner layer strands 3.

An outer layer cladding 12 covers the periphery of the outer layer 8. The outer layer cladding 12 is structured by a high-friction resin material having a coefficient of friction equal to or greater than 0.2, for example, polyurethane resin.

The diameter of all of the wires 5, 6, 10, and 11 is set to be equal to or less than 1/400-th of that of the applicable sheave, that is, the diameter of the sheave around which the elevator rope is wound.

The steel core rope 2 is disposed in the center portion with this type of elevator rope, and the outer layer strands 9, which have a diameter smaller than the inner layer strands 3, are disposed on the periphery of the core rope 2, and therefore high-density packaging of the steel wires 5, 6, 10, and 11, can be achieved while suppressing the overall diameter, and the rope can obtain higher strength.

Further, the inner layer cladding 7, which is made of a resin, is disposed between the inner layer rope 1 and the outer layer 8. Therefore, the inner layer strands 3 and the outer layer strands 9 are prevented from directly contacting each other or rubbing together, so that both degradation due to abrasion can be prevented and bending stress due to buffer action can be relieved, allowing longer service life to be planned for the elevator rope.

In addition, an outer layer cladding 12 is disposed on a portion that contacts with a sheave (not shown in the figures), and therefore abrasion of the outer layer strands 9 due to direct contact with the sheave can also be prevented. Further, the bending stress generated by the wires 10 and 11 of the outer layer strands 9 crushing up against the sheave can be relieved, so that longer service life can be planned for the elevator rope as well as smaller diameters for the sheave.

In addition, the outer layer cladding 12 is disposed in the outermost periphery. Therefore, abrasion of the sheave side can be prevented, and the degree of freedom in material selection for the wires 10 and 11 of the outer layer strands 9, and the sheave can be increased. The overall strength can therefore be further increased, and the sheave can be structured at low cost.

Furthermore, the outer layer cladding 12 that contacts the driving sheave is structured by a high-friction resin material such as polyurethane resin, for example, and therefore sufficient driving force transmission efficiency can be assured, even if the diameter of the driving sheave is made small. It is therefore not necessary to increase the car weight in order to increase the frictional force between the elevator rope and the driving sheave, nor is it necessary to add a guide pulley in order to increase the angle at which the elevator rope winds around the sheave, so that the elevator apparatus structure is not complicated.

Resins having coefficients of friction equal to or greater than 0.2 are suitable for use as the high-friction resin so that sufficient driving force transmission efficiency can be ensured.

Further, although polyurethane resins, from soft ones to hard ones, can be freely selected, it is preferable to use a polyurethane resin having a hardness equal to or greater than 90 in order to ensure the abrasion resistance with respect to minute slippage on the sheave surface. In addition, ether resins are more preferable than ester resins in order to prevent hydrolysis that occurs due to the usage environment.

In addition, the bending resistance can be reduced by selecting a material that freely and easily slides when the elevator rope is bent by the sheave as the inner layer cladding 7. Furthermore, it is necessary that the inner layer cladding 7 has a hardness such that there is no crushing between the wires 6 of the inner layer strands 3, or between the wires 11 of the outer layer strands 9. A low-friction, hard polyethylene material is preferable as this type of material.

Further, it is not necessary that the inner layer cladding 7 have a large coefficient of friction compared to the outer layer cladding 12, and moreover, since its bending around the sheave is not large, superior extensibility is not always necessary. Resins such as nylon, silicon, polypropylene, and polyvinyl chloride, may therefore be used as the material for the inner layer cladding 7. Reductions in service life in cases of using steel inner layer rope 1 can therefore be controlled by using this type of inner layer cladding 7.

In addition, the outer layer strands 9 have a simple 7-wire structure including the center wire 10 and the six peripheral wires 11, and therefore the diameter of the elevator rope can be made smaller, deformation does not easily occur, and covering by the outer layer cladding 12 can be performed easily.

Furthermore, the cross sectional structure of the inner layer strands 3 has a Warrington shape, instead of a Seale shape or a Filler shape, and therefore extremely fine wires 6 are not used, breakage of the wires 6 due to wear can be avoided, and a long service life can be achieved. Further, it is preferable for the wires 6 of the inner layer strands 3 to not be twisted in a crossing manner but twisted in parallel, in order to achieve a long service life. By making the number of wires 6 disposed in the peripheral portion equal to, or two times, the number of wires 6 disposed on the inside thereof, the wires 6 can be disposed with good balance without difficulty, and the wear of the wires 6 can be avoided even more.

Further, there is a danger with multi-layer structure elevator ropes that a rotational torque will be generated in an inner portion in a twisting return direction due to tensile forces caused by loads or repeated bending over time caused by the sheave. Thus, balance between the layers in carrying load will be lost, the cutting strength and the service life will be reduced, and the adhesive power between the claddings 7 and 12 will drop.

In contrast to this, by twisting the inner layer strands 3 in a direction opposite to that of the core strand 4, and by twisting the outer layer strands 9 in a direction opposite to that of the inner layer strands 3, the rotational torque of the inner portion can be put in balance, and a twisting return torque of the overall rope can be reduced.

Further, for cases of winding an elevator rope having high flexibility, like that described above, around a small-diameter sheave, there is a danger that, if the outer layer cladding 12 should be damaged, then contact pressure between the sheave and the outer layer strands 9 will increase, and wear of the sheave and the outer layer strands 9 will progress dramatically.

It is therefore preferable that the number of outer layer strands 9 be set equal to or greater than, 12 (21 in FIG. 1) for cases in which a sheave having a diameter equal to 20 times the diameter of the elevator rope is applied. Further, it is preferable that the number of outer layer strands 9 be set equal to or greater than 16 for cases in which a sheave having a diameter equal to 15 times the diameter of the elevator rope is applied.

An increase in the contact pressure between the sheave and the outer layer strands 9 can thus be suppressed, and wear between the sheave and the outer layer strands 9 can thus be controlled, if the outer layer cladding 12 should be damaged. It is therefore not necessary to use a particularly expensive material for the sheave, and the sheave can be structured at low cost.

In addition, with a rope that does not have the outer layer cladding 12, its service life is determined by the number of times tensile forces and bending stress caused by the sheave are repeatedly applied, and breakage occurs first from the wires of the rope surface. However, the contact pressure with the sheave is reduced with a rope, for which the outer layer cladding 12 is used, and therefore it becomes easier for the wires of the inner portion, not the rope surface, to preferentially undergo breakage due to bending fatigue.

It has been found by experimental research by the inventors of the present invention that life expectancy based on bending fatigue meets a relationship shown by the following equation.

Lifetime Calculation Equations

Equation for Calculating Breakage of Wires Contacting Sheave

Life expectancy Nc=10.0×k×1.05^{D/d}

Equation for Calculating Breakage of Wires at the Rope Inner Portion

Life expectancy Nn=19.1×k×1.05^{D/d}

(where k is a coefficient determined by the rope structure and the rope strength)

If the D/d value that makes the life expectancy Nn equal to the Nc value when D/d=40 is found,the D/d value becomes 26.7. Therefore, if one tries to ensure lifetime equivalent to that under conditions at which a conventional general elevator rope is applied, that is, when D/d=40, the diameter of the inner layer rope 1 must be made equal to or less than 1/27-th of the diameter of the sheave. In other words, a sheave having a diameter equal to or greater than 27 times the diameter of the inner layer rope 1 must be used.

Further, with the above-mentioned elevator rope, the diameters of all of the wires 5, 6, 10, and 11 are set to be equal to or less than 1/400-th of the diameter of the sheave applied, and therefore the bending fatigue lifetime is not reduced, even if the diameter of the sheave applied is made small.

Embodiment 2.

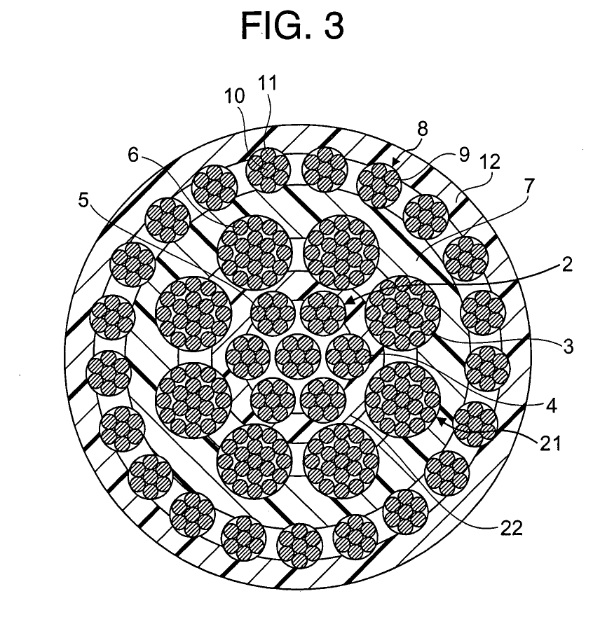

Next, FIG. 3 is a cross sectional diagram of an elevator rope in accordance with Embodiment 2 of the present invention. In the figure, an inner layer rope 21 has the core rope 2, a core rope cladding 22 that covers the periphery of the core rope 2, and the plural inner layer strands 3 provided in a peripheral portion of the core rope cladding 22. A lubricating oil is coated onto the wires 5 of the core strands 4 and the wires 6 of the inner layer strands 3. Other structures are similar to those of Embodiment 1.

The lubricating oil is coated onto the core strands 4 and the inner layer strands 3 of the inner layer rope 21, and therefore breakage due to abrasion of the wires 5 and 6 of the inner layer rope 21 can be prevented with this type of elevator rope, and a long service life can be achieved. Further, the inner layer cladding 7 is provided in the periphery of the inner layer rope 21, and therefore outflow of the lubricating oil to the outer layer 8 is prevented, and adhesion between the outer layer strands 9 and the outer layer cladding 12 can be ensured.

In addition, the periphery of the core rope 2 is covered by the core rope cladding 22, and therefore abrasion due to contact between the core rope 2 and the inner layer strands 3 can be prevented.

Embodiment 3.

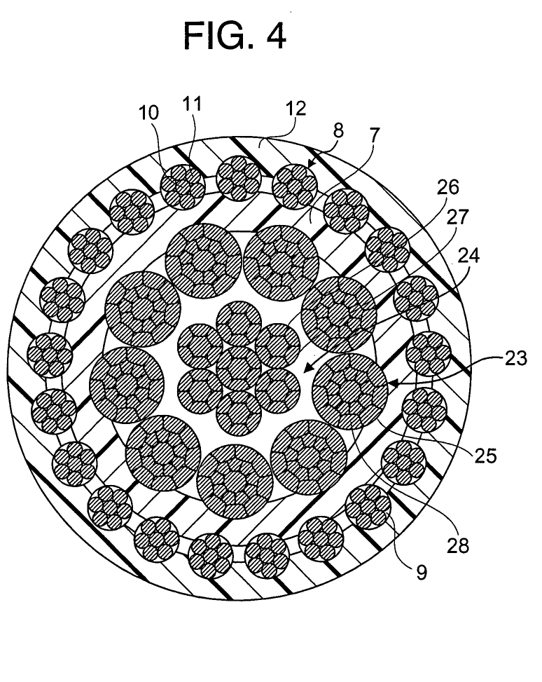

Next, FIG. 4 is a cross sectional diagram of an elevator rope in accordance with Embodiment 3 of the present invention. In the figure, an inner layer rope 23 has a core rope 24, and a plurality of inner layer strands 25 provided in a peripheral portion of the core rope 24. The core rope 24 has a plurality of core strands 26. Each of the core strands 26 is structured by mutually twisting a plurality of steel wires 27.

The inner layer strands 25 are structured by mutually twisting a plurality of steel wires 28. The cross section of the wires 28 of the inner layer strands 25 is deformed by compressing the inner layer strands 25 from the periphery. The cross section of the wires 27 of the core strands 26 is deformed by compressing the core strands 26 from the periphery. Other structures are similar to those of

Embodiment 1.

With this type of elevator rope, the wires contact with each other along a surface or a line, not at a point, by twisting them at the time of manufacturing the inner layer strands 25 and the core strands 26 to have a diameter on the order of 5% greater than the finished diameter, and then passing them through finished-diameter dies. The packaging density of the wires 27 and 28 can thus be increased. Further, the contact pressure between the wires 27 and between the wires 28 is reduced, and abrasion of the wires 27 and 28 is controlled. In addition, deformation of the inner layer strands 25 and the core strands 26 is prevented, and a long life can be achieved.

Embodiment 4.

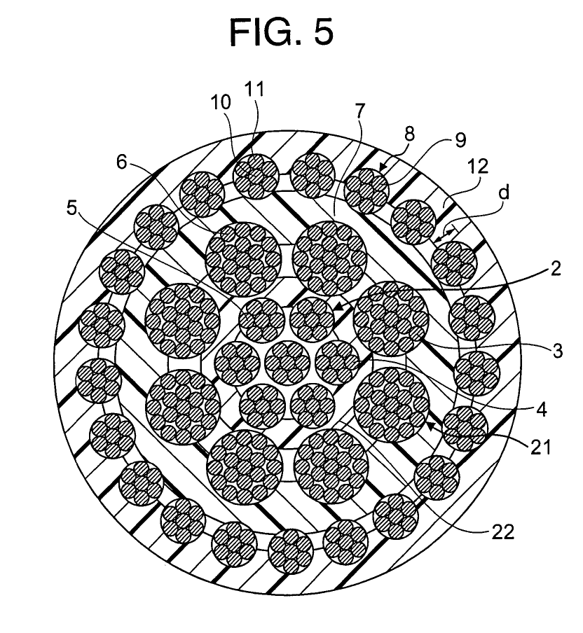

Next, FIG. 5 is a cross sectional diagram of an elevator rope in accordance with Embodiment 4 of the present invention. In the figure, the outer layer cladding 12 enters between mutually adjacent outer layer strands 9. An intrusion depth d of outer layer cladding 12 from the surface of the outer layer 8 becomes greater than the radius of the outer layer strands 9, for example. Further, the intrusion depth d can be regulated during formation of the outer layer cladding 12 by increasing the temperature of the resin material of the outer layer cladding 12, pressure injecting it while in a die for executing the cladding, and by creating a vacuum from the rope inner portion, for example. Other structures are similar to those of Embodiment 2.

The outer layer cladding 12 enters deeply between mutually adjacent outer layer strands 9 with this type of elevator rope, to therefore prevent movement and mutual contact of the outer layer strands 9, abrasion of the peripheral wires 11 of the outer layer strands 9, and deformation of the outer layer strands 9. Longer life of the elevator rope can thus be achieved.

Embodiment 5.

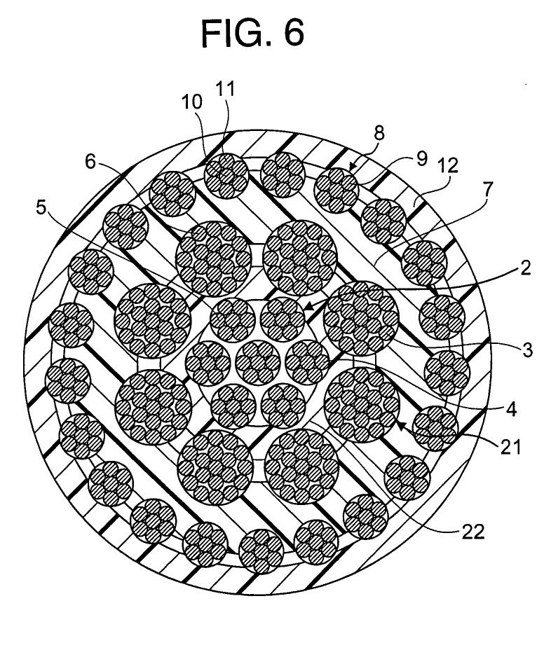

Here, although the outer layer cladding 12 enters between the outer layer strands 9 in Embodiment 4, the inner layer cladding 7 may also enter between the outer layer strands 9, for example, as shown in FIG. 6.

Further, the inner layer cladding 7 may also enter between mutually adjacent inner layer strands 3.

In addition, the core rope cladding 22 may also enter between mutually adjacent inner layer strands 3, and mutually adjacent core strands 4.

Embodiment 6.

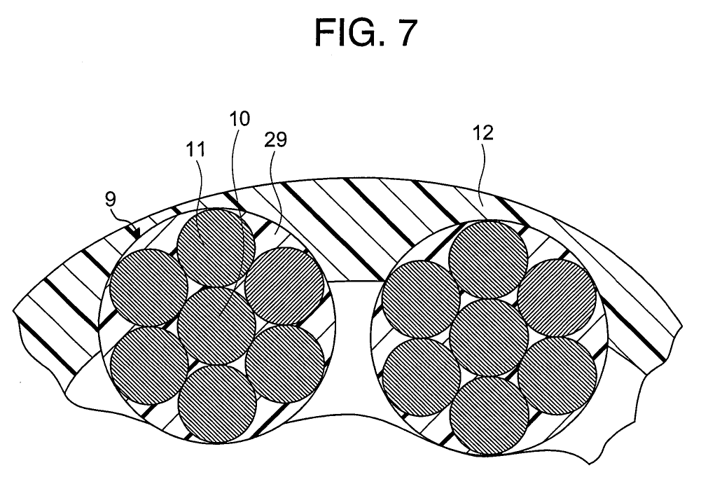

Next, FIG. 7 is a cross sectional diagram of main portions of an elevator rope in accordance with Embodiment 6 of the present invention. In the figure, the periphery of the outer layer strands 9 is covered with a strand cladding 29 made from the same material as the outer layer cladding 12. Other structures are similar to those of Embodiment 1.

The strand cladding 29 is formed in the periphery of the outer layer strands 9 when manufacturing the outer layer strands 9 with this type of elevator rope. The strand cladding 29 is made of the same material as the outer layer cladding 12, and therefore has a superior adhesion with the outer layer cladding 12. The outer layer strands 9 are therefore strongly fixed to the outer layer cladding 12, through the strand cladding 29, and peeling from the outer layer cladding 12 of the outer layer strands 9 is prevented. Note that rusting during storage until the outer layer strands 9 are used in the next step is prevented by constructing the strand cladding 29 when manufacturing the outer layer strands 9, and stable product quality can be ensured.

Embodiment 7

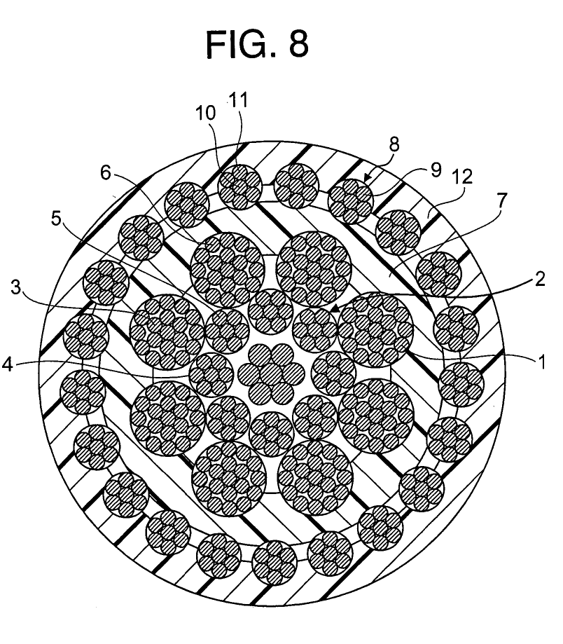

Next, FIG. 8 is a side elevation diagram showing the elevator rope in accordance with Embodiment 7 broken down into layers. In the figure, the inner layer strands 3 are in direct contact with a peripheral surface of the core rope 2. The number of the core strands 4 disposed in the peripheral portion of the core rope 2 (8, here) is the same as the number of inner layer strands 3 (8, here). The core strands 4 are mutually twisted together, and the inner layer strands 3 are twisted in the same direction as the core strands 4. Other structures are similar to those of Embodiment 1.

The inner layer strands 3 and the core strands 4, which are in contact with each other are the same in terms of their number and twisting direction, with this type of elevator rope. Therefore, the inner layer strands 3 and the core strands 4 cross without contact, and the core strands 4 can be disposed evenly with respect to the inner layer strands 3. Damage due to abrasion of the inner layer strands 3 and the core strands 4 can therefore be controlled, and a long service life can be achieved.

Further, although the twisting return torques of the inner layer strands and the core strands 4 are totaled in this case, the total twisting return torque of the inner layer strands 3 and the core strands 4 can be suppressed provided that the twisting pitch of the inner layer strands and the core strands 4 is increased, and the total torque can balance with the twisting return torque of the outer layer strands 9.

Note that, in Embodiments 1 to 7, it is preferable that the strength of the outer layer 8, which is the total of the strengths of each of the outer layer strands 9, be set so as to fall within 20% or less of the strength of the overall elevator rope. A residual strength of 80% can thus be ensured by only the inner layer rope 1, even if outer layer strands 9, which have the highest bending stress, undergo breakage, and thus reliability can be increased.

Note that the multi-layer structure rope shown in Embodiments 1 to 7 is characterized in that the load carrying ratio of the layers changes due to fatigue with time. Although this also differs in accordance with the rope structure, the strength bearing ratio of the layers in which damage advances is preferentially made smaller. That is, it is preferable to detect abnormalities and exchange the weakest layers, before the overall strength is dramatically reduced, by setting the strength of one layer to 20 to 80%.

For example, it is preferable to set the total strength of the outer layer strands 9, which constitute the weakest layer and have the highest bending stress, to fall within 20% or smaller of the overall strength of the elevator rope. A residual strength of nearly 80% can therefore be ensured by only the inner layer rope 1, even for cases in which the outer layer strands 9 undergo breakage, and the reliability can be increased.

Further, if the peripheral wires 11 of the outer layer strands 9 are twisted by repulsive twisting in this case, without being pre-formed (non-repulsive twisting), then breakage detection is easy. That is, if the peripheral wires 11 undergo breakage, then a breakage portion emerges upward and protrudes to the outside of the outer layer cladding 12. The breakage of the peripheral wires 11 can therefore be observed visually, lifetime judgement for the overall rope can be performed very accurately, and the reliability can be increased. Further, there is no need to use a flaw detection apparatus or the like in order to detect the breakage condition, and therefore the maintenance costs can be made low.

Note that, for cases in which the service life of the core strands 4 of the inner layer rope 1 is shorter than that of the outer layer strands 9, as in cases where the core strands 4 are not covered and deformation processing is not performed, it is effective to set the strength of the inner layer rope 1 to be 20% of the overall strength and to pre-form the outer layer strands 9.

Embodiment 8.

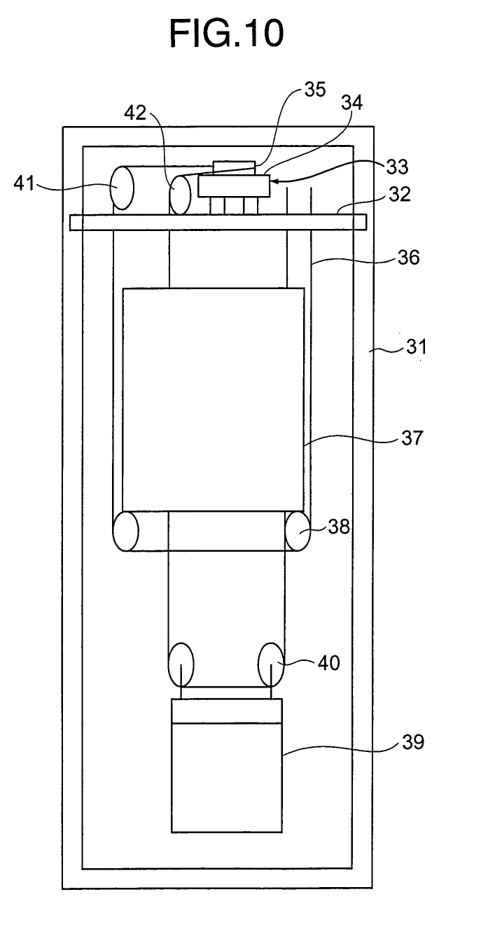

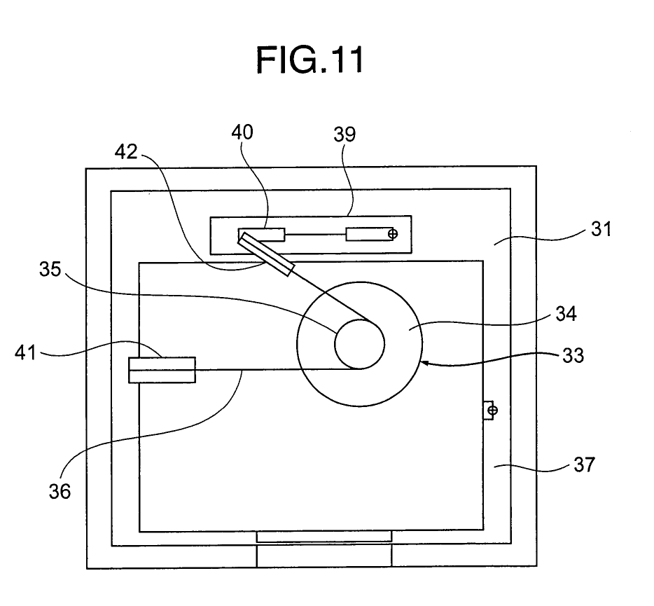

FIG. 10 is a schematic front elevation diagram showing an elevator apparatus in accordance with Embodiment 8 of the present invention, and FIG. 11 is a plan view showing the elevator apparatus of FIG. 10. In the figures, a support platform 32 is fixed to an upper portion within an elevator shaft 31. A thin-shape drive machine 33 is mounted on the support platform 32. The drive machine 33 has a motor 34, and a driving sheave 35 that is rotated by the motor 34. Further, the drive machine 33 is disposed horizontally so that the rotating shaft of the driving sheave 35 extends vertically.

An elevator rope 36 having the structure of any one of Embodiments 1 to 7 is wound around the driving sheave 35. One end portion 36a and an other end portion 36b of the elevator rope 36 are connected to the support platform 32 through a belay (not shown in the figures).

A car 37 is suspended down between the one end portion 36a of the elevator rope 36 and the driving sheave 35. A pair of car suspension sheaves 38, around which the elevator rope 36 is wound, are provided in a lower portion of the car 37.

A counterweight 39 is suspended down between the other end portion 36b of the elevator rope 36 and the driving sheave 35. A pair of counterweight suspension sheaves 40, around which the elevator rope is wound, are provided on an upper portion of the counterweight 39. The car 37 and the counterweight 39 are raised and lowered within the elevator shaft 31 by the drive machine 33, through the elevator rope 36.

A car side guide pulley 41 for guiding the elevator rope 36 extending from the driving sheave 35 to the car 37 is disposed at an upper portion within the elevator shaft 31. Further, a counterweight side guide pulley 42 for guiding the elevator rope 36 extending from the driving sheave 35 to the counterweight 39 is disposed at the upper portion of the elevator shaft 31.

The drive machine 33, the car side guide pulley 41, and the counterweight side guide pulley 42 are disposed so as to overlap with the car 37 within a vertical projection plane. Further, the diameters of the car side guide pulley 41 and the counterweight side guide pulley 42 are set to be equal to or greater than 15 times, and equal to or less than 20 times, the diameter of the elevator rope 36.

A sufficient rope service life can be maintained with this type of elevator apparatus by using the elevator rope 36 having high strength, long service life, and high friction, if the diameter of the car side guide pulley 41 and the diameter of the counterweight side guide pulley 42 are equal to or greater than 15 times, and equal to or less than 20 times, the diameter of the elevator rope 36.

The car side guide pulley 41 and the counterweight side guide pulley 42 can therefore be disposed in spaces above the car 37 without making the height dimension of the elevator shaft 31 larger, and it is not necessary to widen the transverse area of the elevator shaft 31.

Note that it is preferable that the diameter of the car side guide pulley 41 and the diameter of the counterweight side guide pulley 42 be equal to or greater than 15 times the rope diameter with elevator apparatuses having low operational frequencies in practical use, and equal to or greater than 20 times the rope diameter with elevator apparatuses having high operational frequencies. A sufficient service life can thus be ensured. Further, it is preferable to set the diameters of the guide pulleys 41 and 42 equal to or smaller than 30 times the rope diameter in order to suppress the height dimension of the elevator shaft 31. In particular, the height dimension of the elevator shaft 31 can be effectively made smaller provided that the diameters of the guide pulleys 41 and 42 are set equal to or smaller than 15 to 20 times the rope diameter. In addition, the height dimension of the elevator shaft 31 can be effectively made smaller provided that the diameters of the guide pulleys 41 and 42 are set equal to or smaller than the installation height of the drive machine 33.

1. An elevator rope comprising:
an inner layer rope having a plurality of inner layer strands in which a plurality of steel wires are twisted together;
an inner layer cladding made of a resin and covering a periphery of the inner layer rope;
an outer layer formed in a peripheral portion of the inner layer cladding and having a plurality of outer layer strands in which a plurality of steel wires are twisted together; and
an outer layer cladding made of a high-friction resin material and covering a periphery of the outer layer.

2. An elevator rope according to claim 1, wherein a coefficient of friction of the high-friction resin material is equal to or greater than 0.2.

3. An elevator rope according to claim 1, wherein the high-friction resin material is polyurethane resin.

4. An elevator rope according to claim 1, wherein the inner layer cladding is made of a polyethylene resin.

5. An elevator rope according to claim 1, wherein the outer layer strands are structured by a center wire disposed in the center, and six peripheral wires disposed on the periphery of the center wire.

6. An elevator rope according to claim 1, wherein a cross-sectional structure of the inner layer strands is of Warrington shape.

7. An elevator rope according to claim 1, wherein: the inner layer rope has a core rope that contains a plurality of core strands in which a plurality of steel wires are twisted together, and the inner layer strands provided on a peripheral portion of the core rope; the core strands are mutually twisted together; the inner layer strands are twisted in a direction opposite to that of the core strands; and the outer layer strands are twisted together in a direction opposite to that of the inner layer strands.

8. An elevator rope according to claim 1, wherein 12 or more of the outer layer strands are used.

9. An elevator rope according to claim 1, wherein a diameter of the inner layer ropes is set equal to or less than 1/27-th of a diameter of a sheave that is applied.

10. An elevator rope according to claim 1, wherein diameters of each of the wires are set equal to or less than 1/400-th of the diameter of a sheave that is applied.

11. An elevator rope according to claim 1, wherein the wires of the outer layer strands are twisted by repulsive twisting.

12. An elevator rope according to claim 1, wherein a lubricating oil is applied to the inner layer rope.

13. An elevator rope according to claim 1, wherein a cross section of the wires of the inner layer strands is deformed by compressing the inner layer strands from the periphery.

14. An elevator rope according to claim 1, wherein at least one of the outer layer cladding and the inner layer cladding enters between mutually adjacent outer layer strands.

15. An elevator rope according to claim 1, wherein the inner layer cladding enters between the inner layer strands disposed on a peripheral portion of the inner layer rope.

16. An elevator rope according to claim 1, wherein the periphery of the outer layer strands is covered by a strand cladding made of the same material as the outer layer cladding.

17. An elevator rope according to claim 1, wherein: the inner layer rope has a core rope that contains a plurality of core strands in which a plurality of steel wires are twisted together, and the inner layer strands provided on a peripheral portion of the core rope; the number of core strands disposed in the peripheral portion of the core ropes is equal to the number of inner layer strands; the core strands are mutually twisted together; and the inner layer strands are twisted in a direction identical to that of the core strands.

18. An elevator rope according to claim 1, wherein a total strength obtained by adding strengths of each of the outer layer strands is set to fall within 20% or less of the strength of the overall elevator rope.

19. An elevator rope according to claim 1, wherein a strength of the inner layer ropes is set to fall within 20% or less of the strength of the overall elevator rope.

20. An elevator apparatus comprising:
an elevator shaft;
a drive machine having a motor, and a driving sheave that is rotated by the motor, which is disposed at an upper portion of the elevator shaft so that a rotating shaft of the driving sheave extends vertically;
an elevator rope having an inner layer rope that possesses a plurality of inner layer strands in which a plurality of steel wires are twisted together, an inner layer cladding made of a resin and covering a periphery of the inner layer rope, an outer layer formed in a peripheral portion of the inner layer cladding and possessing a plurality of outer layer strands in which a plurality of steel wires are twisted together, and an outer layer cladding made of a high-friction resin material and covering a periphery of the outer layer, with the elevator rope wound around the driving sheave;
a car and a counterweight that are suspended down within the elevator shaft by the elevator rope, and are raised and lowered by the drive machine;
a car side guide pulley disposed at an upper portion of the elevator shaft for guiding the elevator rope extending from the driving sheave to the car; and
a counterweight side guide pulley disposed at the upper portion of the elevator shaft for guiding the elevator rope extending from the driving sheave to the counterweight,
wherein the drive machine, the car side guide pulley and the counterweight side guide pulley are disposed so as to overlap with the car within a vertical projection plane, and the diameters of the car side guide pulley and the counterweight side guide pulley are set to be equal to or greater than 15 times the diameter of the elevator rope, and equal to or less than 30 times the diameter of the elevator rope.
